(19) United States
(12) Patent Application Publication
(10) Pub. No.: US 2014/0360686 A1
(43) Pub. Date: Dec. 11, 2014

(54) CONTROL DEVICE FOR RAISING AND LOWERING A ROLLABLE BLIND

(71) Applicant: Ya-Yin LIN, Chiayi City (TW)

(72) Inventor: Ya-Yin LIN, Chiayi City (TW)

(21) Appl. No.: 13/910,264

(22) Filed: Jun. 5, 2013

(51) Int. Cl. E06B 9/42; A47H 5/14

(52) U.S. Cl. CPC E06B 9/42; A47H 5/14
USPC 160/319

(57) ABSTRACT

A control device for a rollable blind includes a fixing seat having a fixing post that defines an axis, and a limiting wall that has an annular first fixing surface. The fixing post has an annular second fixing surface that is spaced apart from the first fixing surface. A cord driven seat includes a sleeve tube that is in sleeving engagement with the fixing post. The sleeve tube has annular first and second rotary surfaces that surround the axis. The first and second rotary surfaces contact intimately and slidably the first and second fixing surfaces. A control cord is operable to drive rotation of the cord driven seat relative to the fixing seat. A blind mounting seat is coupled to the cord driven seat and the rollable blind.

### BACKGROUND OF THE INVENTION

1. Field of the Invention

The present invention relates to a control device for raising and lowering a rollable blind.

2. Description of the Related Art

Referring to FIGS. 1, 2 and 3, R.O.C. patent publication no. M440739 discloses a blind control device 1 that controls the release and reel up of a blind 20. The blind 20 is placed between two hangers 21. The blind control device 1 is placed between one of the hangers 21 and the blind 20, and includes a fixing seat 12. The fixing seat 12 includes a base wall 121, a fixing post 122 extending from the base wall 121 along an axis 11, and a surrounding wall 123 surrounding the periphery of the fixing post 122. The base wall 121 has a two locking grooves 124 adjacent to the fixing post 122. The fixing post 122 has an end portion 125 disposed away from the base wall 121. The surrounding wall 123 has an opening 126.

The blind control device 1 further includes a control seat 13 rotatably disposed on the fixing seat 12, a wheel seat 14 coupled with the control seat 13, a control cord 15, a plurality of resilient components 16 intimately sleeved on the periphery of the fixing post 122, a blind mounting seat 17 sleeved on the control seat 13, a first coupling sleeve 18 sleeved on the fixing post 122 and engaged with the base wall 121, a second coupling sleeve 19 sleeved on the end portion 125 of the fixing post 122 and engaged with the blind mounting seat 17, and a cap 10 that assembles the blind mounting seat 17 and the control seat 13 with the fixing seat 12.

The control seat 13 has two slots 131. When the control seat 13 is not being rotated, the resilient components 16 are intimately sleeved on the fixing post 122 of the fixing seat 12. Each of the resilient components 16 has two legs 161 extending respectively into the slots 131. When the control seat 13 is being rotated, the two legs 161 are acted upon by the control seat 13 to release the resilient components 16 from gripping the fixing post 122. As to how the resilient components 16, the fixing post 122 and the control seat 13 can cooperate to temporarily restrain the control seat 13 is well known in the art and will not be further described herein.

The blind control device 1 has the first coupling sleeve 18 disposed between the fixing seat 12 and the control seat 13 to reduce the friction therebetween when rotation is actuated through the control cord 15. The second coupling sleeve 19 is disposed between the fixing post 122 and the blind mounting seat 17 to reduce the friction therebetween when the control seat 13 is rotating. Although the above-mentioned components act to reduce friction produced between components in the blind control device 1, the assembly of such a device is complicated due to the large number of components required therein.

### SUMMARY OF THE INVENTION

The object of the present invention is to provide a control device for raising and lowering a rollable blind that has a fewer number of components while ensuring smoother rotation, higher stability and less noise.

According to the present invention, there is provided a control device for raising and lowering a rollable blind. The control device includes a fixing seat, a cord driven seat, a control cord, and a blind mounting seat.

The fixing seat includes a fixing post that defines an axis, and a limiting wall that surrounds the axis and that has an annular first fixing surface. The fixing post has an annular second fixing surface that is spaced apart from the first fixing surface and that surrounds the axis.

The cord driven seat includes a sleeve tube that is in sleeving engagement with the fixing post such that the cord driven seat is rotatable relative to the fixing seat about the axis. The sleeve tube has annular first and second rotary surfaces that surround the axis . The first rotary surface contacts intimately and slidably with the first fixing surface. The second rotary surface contacts intimately and slidably with the second fixing surface.

The control cord is coupled operatively to the cord driven seat and is operable to drive rotation of the cord driven seat relative to the fixing seat.

The blind mounting seat is coupled to the cord driven seat so as to be co-rotatable therewith and is adapted to be coupled to the reliable blind.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded view of a control device according to the prior art;

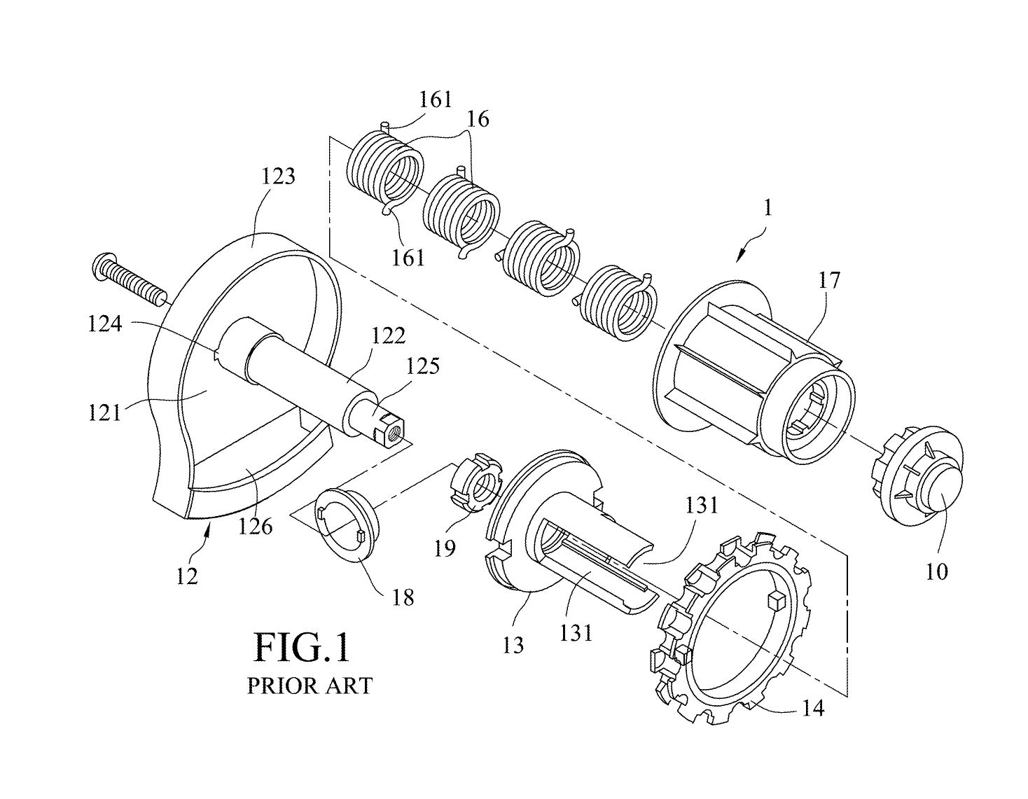

FIG. 2 is a cross sectional view of the control device according to the prior art;

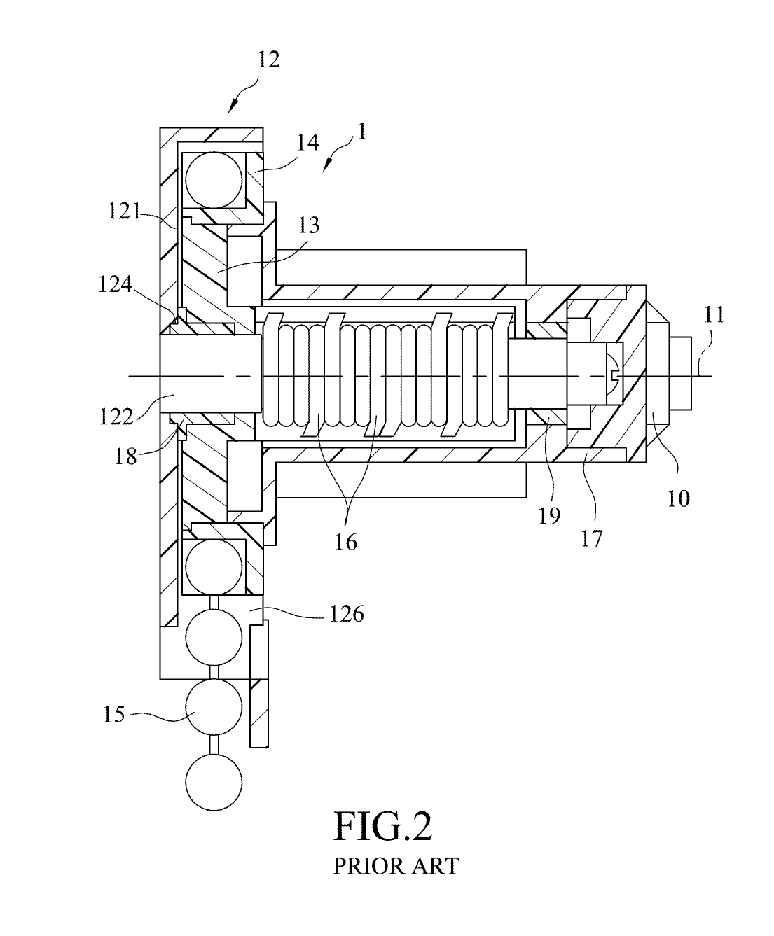

FIG. 3 is an elevation view of the control device according to the prior art in a state of use;

FIG. 4 is an exploded view of a control device according to the preferred embodiment of the present invention;

FIG. 5 is a schematic view of the control device of the preferred embodiment;

FIG. 6 is a cross sectional view of the control device of the preferred embodiment taken along line Vi-Vi in FIG. 5; and

FIG. 7 is a cross sectional view of the control device of the preferred embodiment taken along line VII-VII in FIG. 5.

### DETAILED DESCRIPTION OF THE PREFERRED EMBODIMENT

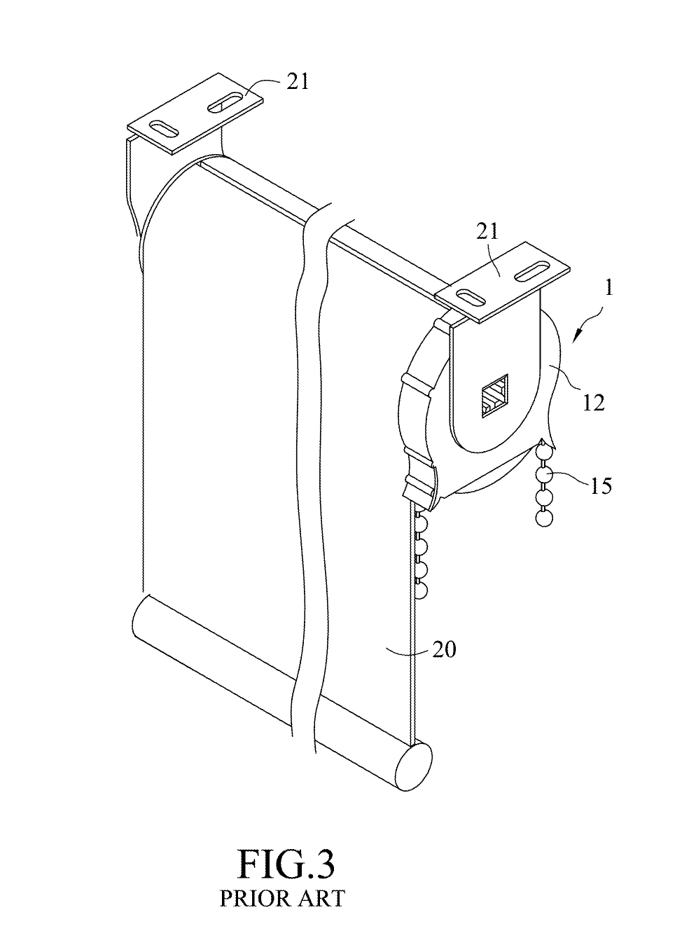

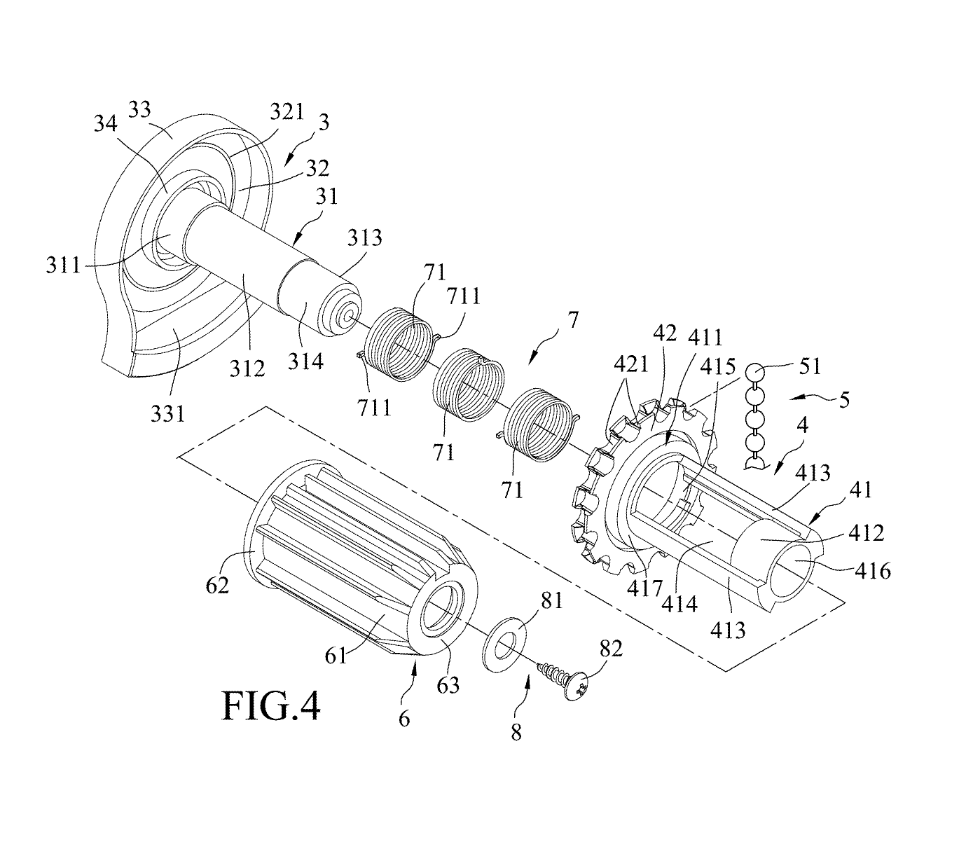

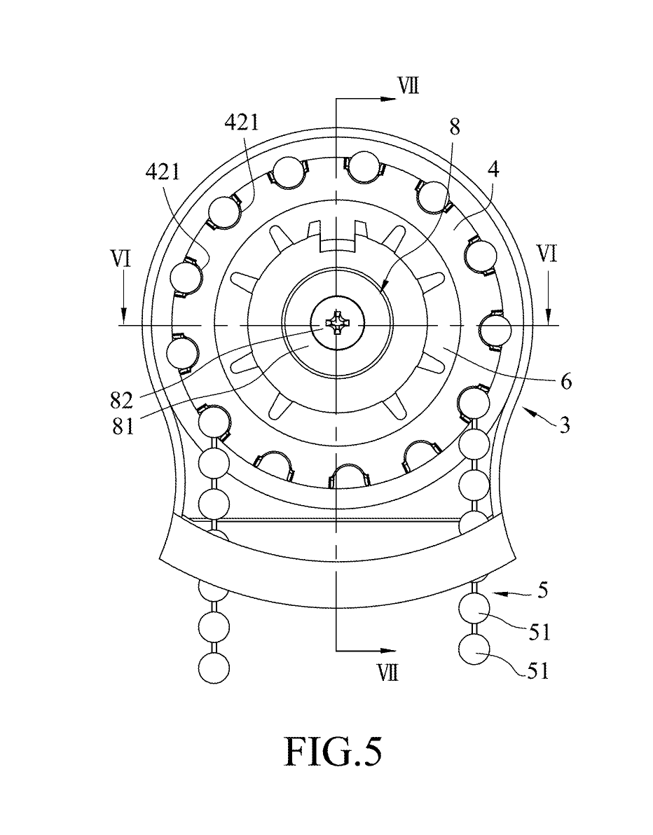

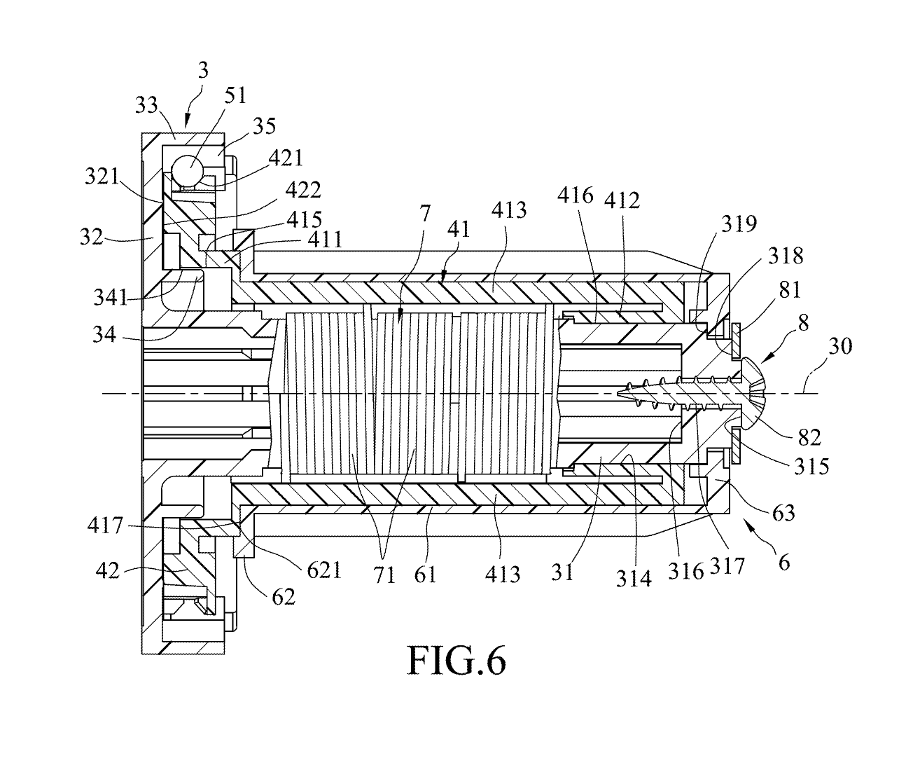

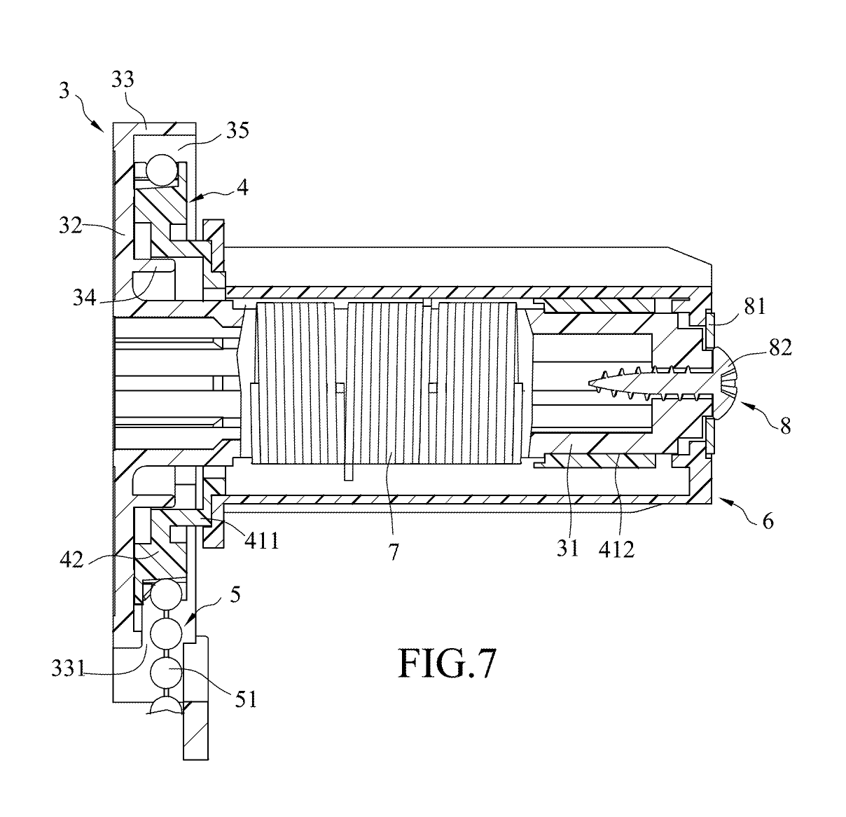

Referring to FIGS. 4, 5, 6 and 7, a control device for raising and lowering a rollable blind (see FIG. 3) in a preferred embodiment of the present invention includes a fixing seat 3, a cord driven seat 4, a control cord 5, a blind mounting seat 6, a resilient unit 7 and a limiting unit 8.

The fixing seat 3 includes a fixing post 31 surrounding an axis 30, a base wall 32 extending in radial outward directions from one end of the fixing post 31, a surrounding wall 33 connected with the base wall 32 and extending in the same direction as the fixing post 31, and a limiting wall 34 that surrounds the axis 30 and that is located between the fixing post 31 and the surrounding wall 33. The limiting wall 34 extends integrally from the base wall 32. The fixing post 31, the surrounding wall 33, and the limiting wall 34 are located on the same side of the base wall 32.

The fixing post 31 has a first post portion 311 adjacent to the base wall 32, a second post portion 312 that connected with the fixing post portion 311 on the axis 30 and that has a smaller radius than that of the first post portion 311, and a tubular mounting segment 313 connected with the second post portion 312 on the axis 30. The tubular mounting segment 313 has a second fixing surface 314 surrounding the axis 30, an outer end face 315 distal from the base wall 32 and transverse to the axis 30, an inner end face 316 disposed between the outer end face 315 and the base wall 32 and disposed parallel to the outer end face 315, a screw hole 317 passing through the outer end face 315 and the inner end face 316, and a first ring surface 318 and a second ring surface 319 disposed between the inner end face 316 and the outer end face 315 and transverse to the axis 30. The surrounding wall 33 has an opening 331 disposed at the bottom thereof. The limiting wall 34 has an annular first fixing surface 341 surrounding and facing away from the axis 30. The fixing seat 3 further includes an annular space 35 cooperately defined by the surrounding wall 33 and the limiting wall 34. The base wall 32 has an annular rib 321 that surrounds the axis 30.

In this preferred embodiment, the cord driven seat 4 includes a sleeve tube 41 that is in sleeving engagement with the fixing post 31 such that the cord driven seat 4 is rotatable relative to the fixing seat 3 about the axis 30, and a cord wheel 42 connected integrally to the sleeve tube 41 and disposed in the annular space 35 of the fixing seat 3. The sleeve tube 41 has a first sleeve segment 411 that is annular and that surrounds the limiting wall 34 of the fixing seat 3, a second sleeve segment 412 that is disposed at a distance away from the first sleeve segment 411, a pair of connecting parts 413 that extend parallel to the axis 30 and that interconnect the first sleeve segment 411 and the second sleeve segment 412, and two slots 414 each disposed between the connecting parts 413. The first sleeve segment 411 has a first rotary surface 415 contacting intimately and slidably the first fixing surface 341, and a first abutment surface 417 being annular and transverse to the axis 30. The second sleeve segment 412 has a second rotary surface 416 contacting intimately and slidably the second fixing surface 314.

The cord wheel 42 has a plurality of bead grooves 421 disposed around the outer periphery of the cord wheel 42, and an annular wheel surface 422 that faces toward the base wall 32 of the fixing seat 3 and that contacts the annular rib 321. The control cord 5 is in the form of a bead chain but should not be limited thereto. The control cord 5 has a plurality of beads 51 that are connected in the form of a chain and that can be fittingly engaged with the bead grooves 421.

The blind mounting seat 6 is coupled with the cord driven seat 4 and the rollable blind. The blind mounting seat 6 includes a sleeve portion 61 that is sleeved over the sleeve tube 41 of the cord driven seat 4, an abutment portion 62 disposed adjacent to the first sleeve segment 411 of the cord driven seat 4, and an end portion 63 disposed at another side of the sleeve portion 61 opposite to the abutment portion 62. The abutment portion 62 has a second abutment surface 621 that abuts against the first abutment surface 417 of the cord driven seat 4.

The resilient unit 7 includes a plurality of resilient components 71 intimately sleeved on the periphery of the fixing post 31. Each resilient component 71 has two legs 711 extending respectively into the slots 414. As to how the plurality of resilient components 71 can temporarily restrain the cord driven seat 4 and the blind mounting seat 6, and how they can reduce the loading during rotation of the cord driven seat 4 as the control cord 5 is being pulled are well known in the art and therefore will not be further described in detail.

The limiting unit 8 includes a washer 81 disposed at the outer end face 315, and a screw 82 engaging the screw hole 317 and mounting the washer 81 onto the fixing post 31. The outer periphery of the washer 81 extends beyond that of the fixing post 31, and the washer 81 assists to retain the blind mounting seat 6 with the fixing seat 3.

In actual use, the control cord 5 can control the cord driven seat 4 to rotate clockwise or anticlockwise relative to the fixing seat 2. Since the blind mounting seat 6 and the cord driven seat 4 are coupled together and the blind is mounted on the blind mounting seat 6, the control cord 5 can be used to control the blind to be released or reeled up. Since the first rotary surface 415 contacts intimately and slidably with the first fixing surface 341 and the second rotary surface 416 contacts intimately and slidably with the second fixing surface 314, the cord driven seat 4 can maintain stability as it is being rotated. The fixing seat 3 provides a stable support for the rollable blind, and produces less noise by minimizing friction produced during rotation of the rollable blind.

Furthermore, the cord wheel 42 of the cord driven seat 4 contacts the annular rib 321 on the base wall 32 of the fixing seat 3. Therefore, when the cord driven seat 4 is rotated in the clockwise or anticlockwise direction, only an annular segment of the cord wheel 42 abuts against the base wall 32, and such minimum contact therebetween can further reduce friction and noise produced.

From the above, the control device of the present invention, by including the first fixing surface 341, the first rotary surface 415, the second fixing surface 314, the second rotary surface 416, the limiting wall 34 integrally formed in the fixing seat 3, and the cord wheel 42 integrally formed with the sleeve tube 41, is able to ensure smoother rotation, higher stability and less noise. The annular rib 321 of the fixing seat 3 further aids to reduce the contact area between the fixing seat 3 and the cord driven seat 4. Moreover, by reducing the number of components required, the manufacturing of the control device of the present invention is facilitated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A control device for raising and lowering a rollable blind, said control device comprising:
a fixing seat including a fixing post that defines an axis, and a limiting wall that surrounds said axis and that has an annular first fixing surface, said fixing post having an annular second fixing surface that is spaced apart from said first fixing surface and that surrounds said axis;
a cord driven seat including a sleeve tube that is in sleeving engagement with said fixing post such that said cord driven seat is rotatable relative to said fixing seat about said axis, said sleeve tube having annular first and second rotary surfaces that surround said axis, said first rotary surface contacting intimately and slidably said first fixing surface, said second rotary surface contacting intimately and slidably said second fixing surface;
a control cord coupled operatively to said cord driven seat and operable to drive rotation of said cord driven seat relative to said fixing seat; and
a blind mounting seat coupled to said cord driven seat so as to be co-rotatable therewith and adapted to be coupled to the rollable blind.

2. The control device as claimed in claim 1, wherein said fixing seat further includes a base wall extending in radial outward directions from one end of said fixing post, said base wall being connected integrally to said fixing post and said limiting wall.

3. The control device as claimed in claim 2, wherein said cord driven seat further includes a cord wheel connected integrally to said sleeve tube and coupled to said control cord.

4. The control device as claimed in claim 3, wherein said cord wheel has an annular wheel surface that faces toward said base wall, and said base wall is formed with an annular rib that surrounds said axis and that abuts against said wheel surface.

5. The control device as claimed in claim 4, wherein:
said sleeve tube includes a first sleeve segment provided with said first rotary surface, a second sleeve segment provided with said second rotary surface, and a pair of connecting parts that extend parallel to said axis and that interconnect said first sleeve segment and said second sleeve segment, said first sleeve segment having a first abutment surface transverse to said axis,
said blind mounting seat having an abutment portion disposed adjacent to said first sleeve segment, said abutment portion having a second abutment surface that abuts against said first abutment surface.

6. The control device as claimed in claim 5, further comprising a limiting unit that retains said blind mounting seat and said cord driven seat on said fixing seat.

7. The control device as claimed in claim 6, wherein:
said fixing post has a tubular mounting segment distal from said base wall and provided with said second fixing surface, said mounting segment having an outer end face distal from said base wall and transverse to said axis, an inner end face disposed between said outer end face and said base wall and disposed parallel to said outer end face, and a screw hole passing through said outer end face and said inner end face,
said blind mounting seat further having a sleeve portion that is sleeved over said sleeve tube and that has said abutment portion disposed at one side thereof, and an end portion disposed at another side of said sleeve portion opposite to said abutment portion,
said limiting unit including a washer disposed at said outer end face, and a screw engaging said screw hole and mounting said washer onto said fixing post, said washer extending in radial outward directions relative to said axis to prevent removal of said blind mounting seat from said cord driven seat.

8. The control device as claimed in claim 7, further comprising a resilient unit that grips said fixing post and that is engageable with said cord driven seat.

9. The control device as claimed in claim 8, wherein said sleeve tube has two slots each disposed between said connecting parts, and said resilient unit includes at least two resilient components each having two legs extending respectively into said slots.
